(19) United States
(12) Patent Application Publication
(10) Pub. No.: US 2006/0085283 A1
(43) Pub. Date: Apr. 20, 2006

(54) System and method for linking automobile buyers and sellers

(76) Inventor: William Griffiths, Loxahatchee, FL (US)

Correspondence Address: WOOD, NGO & EISENBERG, PLLC, 2121 Eisenhower Ave, Suite 200, Alexandria, VA, 22314, US

(21) Appl. No.: 11/252,746

(22) Filed: Oct. 19, 2005

Related U.S. Application Data
(60) Provisional application No. 60/619,711, filed on Oct. 19, 2004.

(51) Int. Cl. G06Q 30/00

(52) U.S. Cl. 705/26

(57) ABSTRACT

A system and method for marketing automobiles. In one aspect of the invention, a website for marketing automobiles, the website comprising functionality as disclosed in FIGS. 9, 10, 12, and 13, alone or in combination. In another aspect of the invention, a world wide web enabled computer system is provided, the computer system comprising: a processor for hosting a website, the website comprising functionality as disclosed in FIGS. 9, 10, 12, and 13, alone or in combination; and a storage means, wherein the storage means is operably coupled to the processor, and wherein the storage means is used to host a plurality of partitions, the plurality of partitions comprise an automobile buyers' partition, an administration partition, and a automobile dealer's partition.

### CROSS-REFERENCE TO RELATED APPLICATIONS

This application claims the benefit of priority from U.S. Provisional Patent Application Ser. No. 60/619,711, filed Oct. 19, 2004, the entire contents of which are incorporated herein by reference.

### STATEMENT REGARDING FEDERALLY SPONSORED RESEARCH OR DEVELOPMENT

Not Applicable.

### FIELD OF THE INVENTION

This invention relates to a system and method for linking automobile buyers and automobile sellers and, more specifically, an on-line system and method linking potential automobile buyers and automobile dealers.

### BACKGROUND OF THE INVENTION

The experience of buying an automobile from an automobile dealer is an unpleasant experience for many automobile buyers, particularly for people who are nervous of sales pressure from automobile salesmen. Thus, there is a need for new ways of bringing potential automobile buyers and automobile dealers (i.e., sellers) together in a mutually satisfying way without the buyer feeling a lot of sales pressure.

There have been several attempts at providing new ways of buying automobiles. U.S. Patent Publication No. 20020010643, published Jan. 24, 2002 to J. B. Chaves, describes in somewhat vague terms, an invention or concept directed to the electronic sales of automobile and related products and services.

U.S. Patent Publication No. 20030229577, published Dec. 11, 2003 to J. A. Nabel, describes an electronic, Internet-based system and method for brokering and managing automobile sales leads. A potential buyer accesses a first user interface through a hyper-link directly from a participating automobile dealer's Internet site or from an advertisement tied to an automobile dealer. By accessing the first user interface, a potential buyer may: (i) configure the characteristics and options available for a desired automobile; (ii) view available pricing information on the selected automobile configuration; and (iii) make an offer to the target automobile dealer for the purchase of the selected automobile having the selected configuration, generating an offer transmittal to be sent to the target automobile dealer. A designated or target automobile dealer receives the offer transmittal and may contact the potential buyer directly to discuss the offer for the configured automobile.

U.S. Patent Publication No. 20030046179, published Mar. 6, 2003 to Anabtawi et al., describes an Internet shopping and buying system that allows a customer to configure an automobile of their choice by selecting options and creating and viewing a graphic model, to locate a dealership, to select a payment option, to locate a specific automobile and to purchase the automobile.

None of the above inventions and patents, taken either singly or in combination, is seen to describe the instant invention as claimed.

### SUMMARY

The invention is a system and method for linking potential automobile buyers (AB members or ABMs) and automobile dealers (AD members or ADMs) using an innovative business method using an on-line server, wherein the server either comprises or is operably linked to a read-write storage device such as, but not limited to, magnetic media, further wherein the storage device comprises a database.

In one non-limiting embodiment of the present invention, the database comprises three modules or partitions: a website administration partition or module, an AB members area partition or module, and an AD members partition or module. The invention optionally allows AB members to set up home web pages in the members' partition. Automobile dealers can register and save their details on the AD members' partition. In exchange for having home web pages, AB members receive details about automobile deals from the automobile dealers. An individual AB member can set up a wish list to filter automobile deals according to the desires and wants of the individual AB member.

In one embodiment, the invention is a website that enables automobile buyers to search all advertised prices-locally, regionally, statewide or nationally for automobiles in which they are interested, from a single website without disclosing any personal information until they are ready to buy. Moreover, automobile buyers can create a wish list of automobile preferences, which can be matched to automobile dealer offerings, such as dealer ads, suitable matches are communicated to matching automobile buyers by means of, for example, a message sent to their email address, mobile phone or web-enabled PDA.

In another embodiment, authorized AD members receive wish lists of AB members having wish lists of preferred automobile preferences that match, or nearly match, AD ads, wherein the near matches satisfy a predetermined matching criterion, such as, but not limited to, 50% or more match rate. For example, based on a predetermined matching criterion, if the wish lists of AB members #12, #124, and #543 nearly match the offering provided by AD member #34, then the wish lists of AB members #12, #124, and #543 are communicated to AD member #34; however, the personal details of AB members #12, #124, and #543 are not communicated to AD member #34. As a result, AD member #34 can prepare tailored offerings, which are then communicated to AB members #12, #124 and #543. Thus, AD members obtain qualified leads that satisfy a predetermined matching criterion and AB members receive offers tailored to satisfy their automobile preferences as laid out in their wish lists.

In another non-limiting embodiment of the present invention, selected AD members can prepare tailored offerings based on reverse searches of AB members' automobile preferences without compromising or revealing the personal contact information of any AB member. In this embodiment, the reverse searches can be speculative, e.g., an AD member might randomly mine the AB members' partition and construct one or more tailored offerings to suit specific AB members' automobile preferences. Alternatively, the reverse search methodology can be part speculative, e.g., an AD member might select to mine automobile preferences that specify a particular make and model of automobile, such as used Ford F1 pick-up trucks.

In yet another embodiment, the inventions permits selected AD members to detect trends such as demand for trucks based on time of year and/or geographical location.

### BRIEF DESCRIPTION OF THE DRAWINGS

FIG. 1 shows an overall view of one embodiment of the present invention, which includes a custom database.

FIG. 2 represents the organization of the custom database of FIG. 1.

FIG. 3 is a layout schematic showing the operation and functionality of one embodiment of the present invention.

FIG. 4 is a flow chart showing one aspect or embodiment of the present invention.

FIG. 6-8 show an exemplary pull down menu feature or field selection protocol.

FIG. 9 is a flow chart showing one aspect or embodiment of the present invention.

FIG. 10 is a flow chart showing one aspect or embodiment of the present invention.

FIGS. 11A and 11B show an exemplary automobile dealer add.

FIG. 12 is a flow chart showing one aspect or embodiment of the present invention.

FIG. 13 is a flow chart showing one aspect or embodiment of the present invention.

FIG. 14 is a flow chart showing one aspect or embodiment of the present invention.

FIG. 15 is a schematic layout of a website according to the present invention.

### DETAILED DESCRIPTION OF THE INVENTION

In the following description, it should be understood that the terms “automobile dealers”, “AD members”, “ADMs”, “auto-dealers”, auto-sellers” and their singular versions (i.e., “automobile dealer”, “AD member”, “ADM”, “auto-dealer”, “auto-seller”) are equivalent and refer to sellers and suppliers of automobiles who wish to sell automobiles such as, but not limited to, saloon cars, minivans, hybrids, trucks, SUVs, alone or in combination. The term “dealer” is intended to cover large dealers with large showrooms and/or lots (e.g., filled with hundreds of used and/or new automobiles), medium sized dealers (e.g., with lots and automobile show rooms housing less than one hundred used and/or new automobiles, small garage owners with small lots, and individuals engaged in selling specific kinds of automobiles, with less than an average of 5 sales per month) Thus, no limitation should be read into the term “dealer” or “automobile dealer”. The invention is intended for use by anyone or any business entity engaged in the legitimate supply of new and/or used automobiles to members of the public, non-profit entities, and for-profit-entities who have a desire to purchase one or more automobiles.

It should be understood that the terms “automobile buyers”, “AB members”, “ABMs”, “auto-buyers”, and their singular versions (i.e., “automobile buyer”, “AB member”, “ABM”, and “auto-buyer”) are equivalent and refer to members of the public who desire or express a desire to buy automobiles such as, but not limited to, saloon cars, minivans, hybrids, trucks, SUVs, alone or in combination. No limitation should be read into the terms “buyer”, “automobile buyer”, or “automobile member”. The invention is intended for use by anyone or any not-for-profit entity or for-profit-business entity (including government departments or agencies) engaged in the legitimate purchase of new and/or used automobiles.

The invention is a system and method 80 for linking members and auto-dealers using an innovative business system.

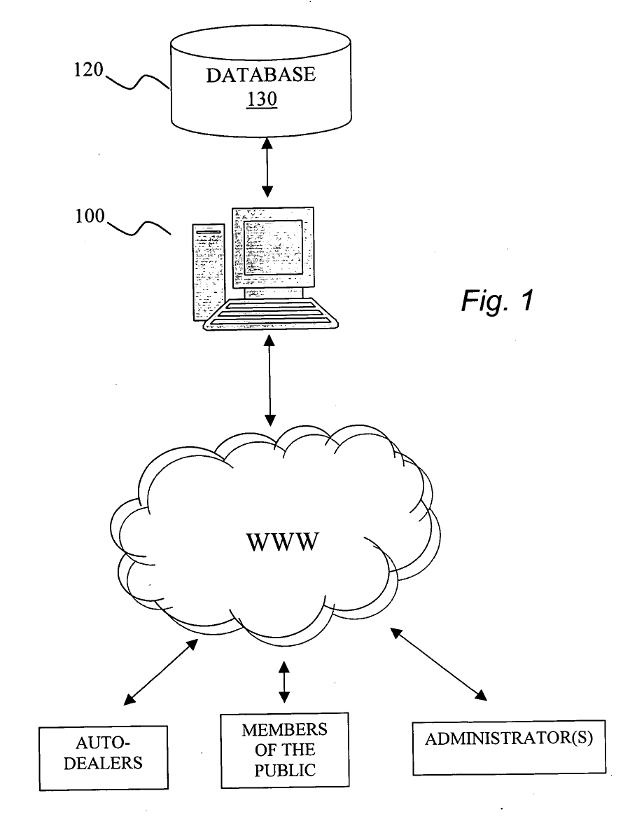

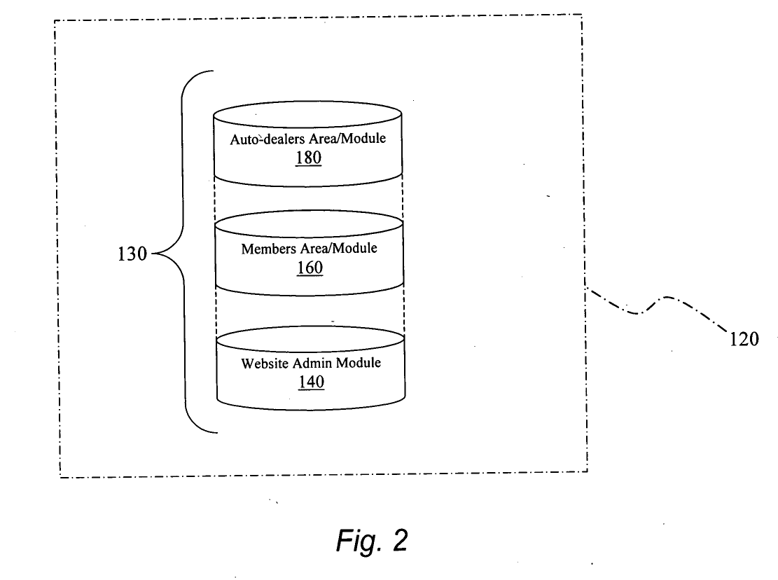

In a first embodiment, the invention 80 includes an on-line computer system such as an on-line server 100 (see FIG. 1), wherein the server 100 either comprises or is operably linked to a read-write storage device 120, such as, but not limited to, magnetic media, wherein the storage device 120 comprises a database 130. In the first embodiment, the database 130 includes three modules or partitions: a website administration partition or module 140, an AB members' partition or module 160, and an AD members partition or module 180 (see FIG. 2). However, the partitions 140, 160 and 180 can be separated and held on separate storage devices alone or in combination. A mirror database may be implemented to improve reliability, e.g., in the event that database 130 fails, its mirrored database can be used to allow continued operation of the invention.

The server 100 is linked to the World-Wide Web (WWW) and uses, for example, the hypertext transfer protocol (“http”) or its functional equivalent. The server 100 is optionally configured to run a secure two-way communication protocol such as https, e.g., http combined with a secure socket layer (known by persons of ordinary skill in the art as “SSL”) such as, but not limited to, the 128-bit encryption system supplied by VeriSign™. Authorized administrators are able to directly access the server 100, and, more particularly, the website administration partition 140 stored on the storage device 120 using a keyboard attached to the server 100 or indirectly via a remote device, such as a remote workstation that is in operable communication with server 100 preferably via a secure LAN or via the WWW (e.g., by means of a secure link such as https).

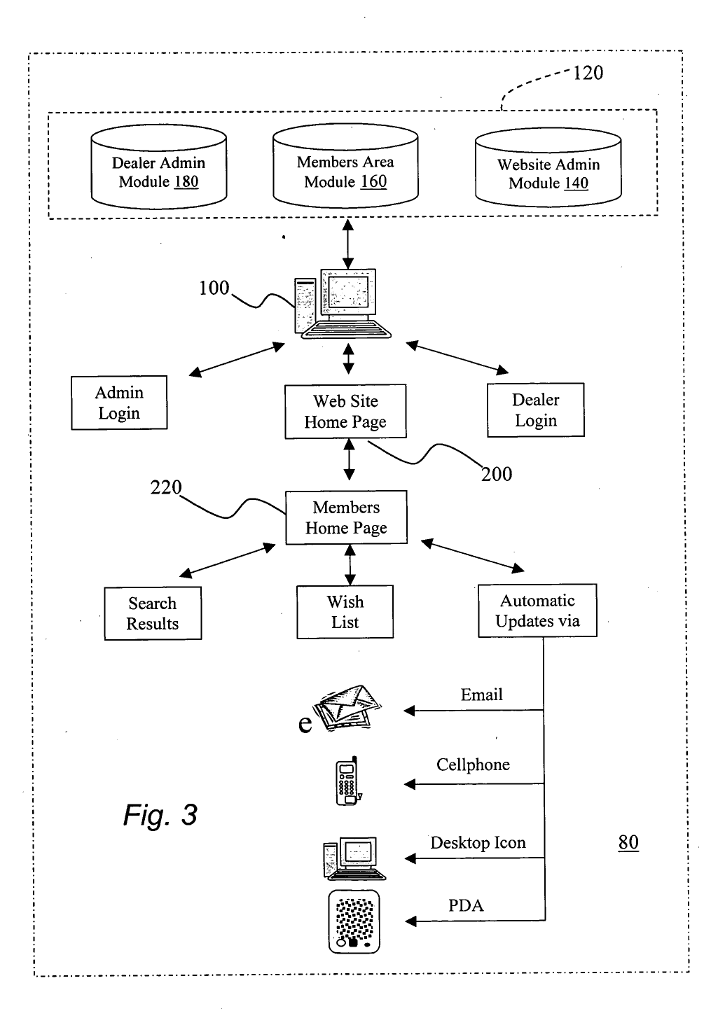

FIG. 3 is a layout schematic showing the operation and functionality of the present invention 80. However, it should be understood that the exact nature of the hardware to run the software of the invention can vary. For example, the server 100 may comprise just one computer processor or at least two processors working in parallel. The invention 80 allows buyers to access a website 200, cell phone or PDA and locate the lowest/best new or used automobile deals/prices/ads, and compare deals for a particular state of the United States (U.S.), group of U.S. states, or the entire U.S. almost instantly. The invention 80 allows new and used automobiles to be instantly advertised to members (i.e., potential automobile buyers) using a variety of electronic media, including website, email, cell phone (wireless), personal digital assistant (PDA), and computer Desktop Icon.

Members of the public (i.e., potential AB members) are invited to set up a home page 220 by setting up an account on the website home page 200. AB members are provided with individual AB member accounts on the AB member partition 160, and more specifically a home page 220. In a preferred embodiment, the AB member enjoys the benefits of a personal or home web page at little or no monetary cost. In exchange for having a personal web page 220, each AB member is required to provide a wish list of preferred automobile features and based on the details stored in their wish list, receives selected ads about automobile deals from AD members.

The invention 80 aggregates and formats ad data so that automobile buyer members (ABMs) can quickly search and compare deals for new or used automobiles using criteria, such as automobile make, model, year, cash, lease or finance for either a single U.S. state or the entire U.S., dealer ads are also formatted in a ‘Top Deals’ list that is provided on the website home page 200.

Automobile buyer members are free to search automobile deals found on the website 200 or receive automobile deals and offers via cell phone or PDA and quickly be able to compare advertised new automobile deals/prices from multiple dealers, either by individual U.S. state or the whole U.S. nearly instantly.

Automobile buyer members (ABMs) can set up a ‘Wish List’ to keep track of best deals/ads for the automobiles according to each member's particular interests. When an automobile dealer member (i.e., automobile seller) posts a “better” deal (i.e., an ad) to the website and if the buyer has not viewed the ad the member receives a notification via their email, cell phone, PDA, or computer Desktop Icon (e.g., by clicking on a desktop icon). A “better deal” refers to an ad that satisfies the ABM's matching requirement.

Automobile dealer members (ADMs), such as, but not limited to, dealerships, can expand their advertising area by individual U.S. state or anywhere in the U.S. The system 80 also provides real time updates of advertised new automobile deals/ads to potential buyers among the members (i.e., members with members home pages 220).

Each seller's new automobile deal/ad can be formatted into:
(i) type—cash, finance, lease;
(ii) deal/ad details—stock #, terms, additional notes;
(iii) deal Price—best/lowest appear top in search results;
(iv) make and model; and
(v) time—ads can run for a predetermined period such as 30 days.

The invention 80 optionally provides real time statistics on advertising effectiveness, showing buyer location, number of buyers viewing all sellers' deals/ads, and each individual deal/ad by hour, day, week, month, and total views. Other statistical data that can be generated using the system 80 includes: the number of times seller deals/ads were displayed on the ‘Top Deals’ list; number of requests for seller to contact buyer; number of requests for buyer to download seller data; and the number of requests to print the seller's deal/ad or contact information.

Automobile dealers' online accounts would be contained, for example, in a multiple security level administration area within an SSL environment. The invention 80 would be created using HTML, PHP, CSS based programming for the website, cell phone and PDA. The database is preferably (but not necessarily) MYSQL based. The invention can be promoted via sponsored links on major and minor search engines, billboards, TV, newspaper, and radio ads. Similarly, ABM accounts could be held, for example, on an automobile buyers' partition 160 within an SSL environment.

The benefits of the present invention 80 include, but are not limited to:

1. the ability for buyers to search, compare multiple advertised new automobile deals/ads, for a particular state, or group of states or the entire U.S. instantly from any suitable location using a website, cell phone, or PDA;

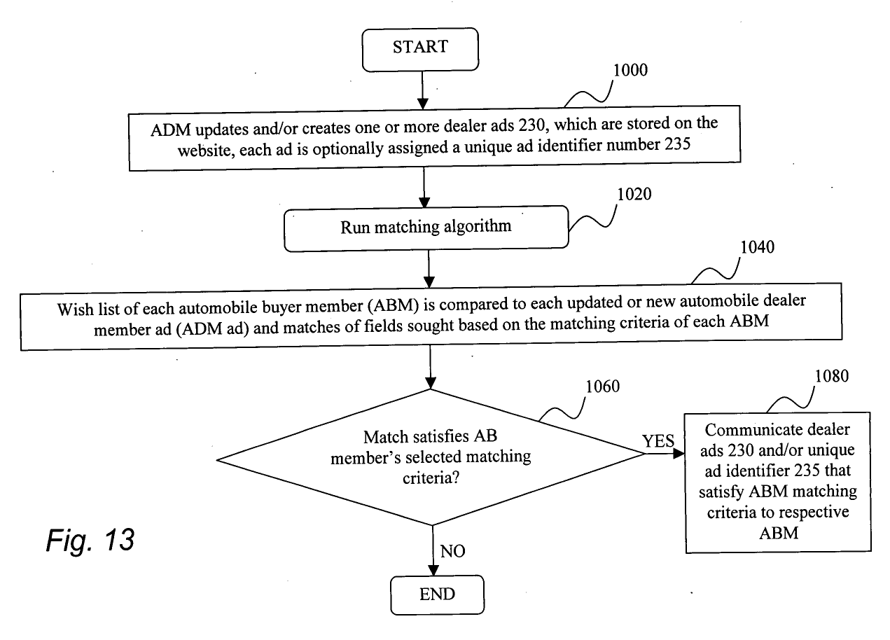

2. buyers to be notified in real time via website, cell phone, PDA and their computer Desktop Icon when a seller adds/updates a new automobile deal/ad (e.g., when a dealer adds and/or updates one or more dealer ads, e.g., see FIG. 13);

3. seller's ability to expand their advertising area, from a single state to the entire U.S.;

4. sellers ability to update new automobile deals/ads; and

5. seller's ability to get real time statistics on advertising effectiveness.

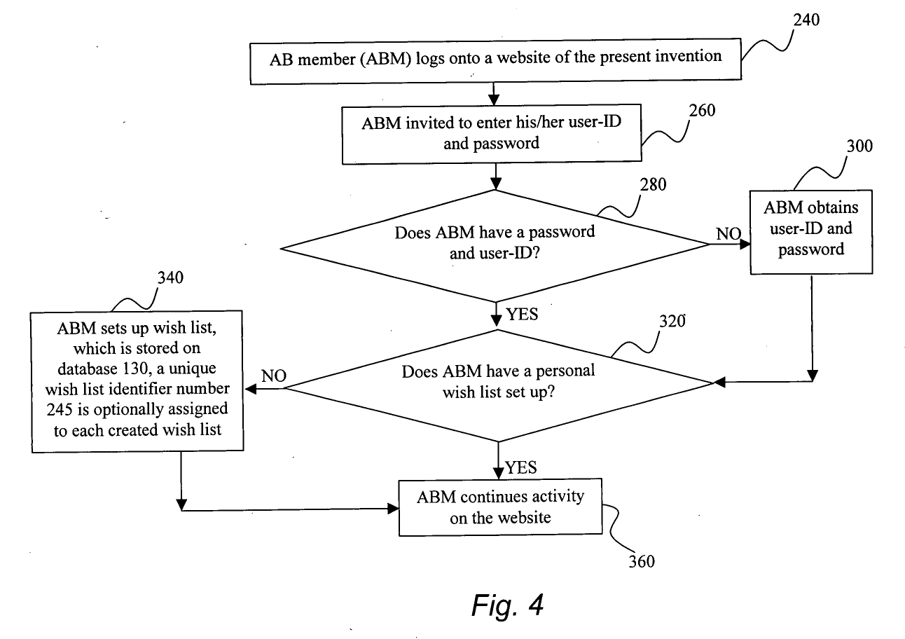

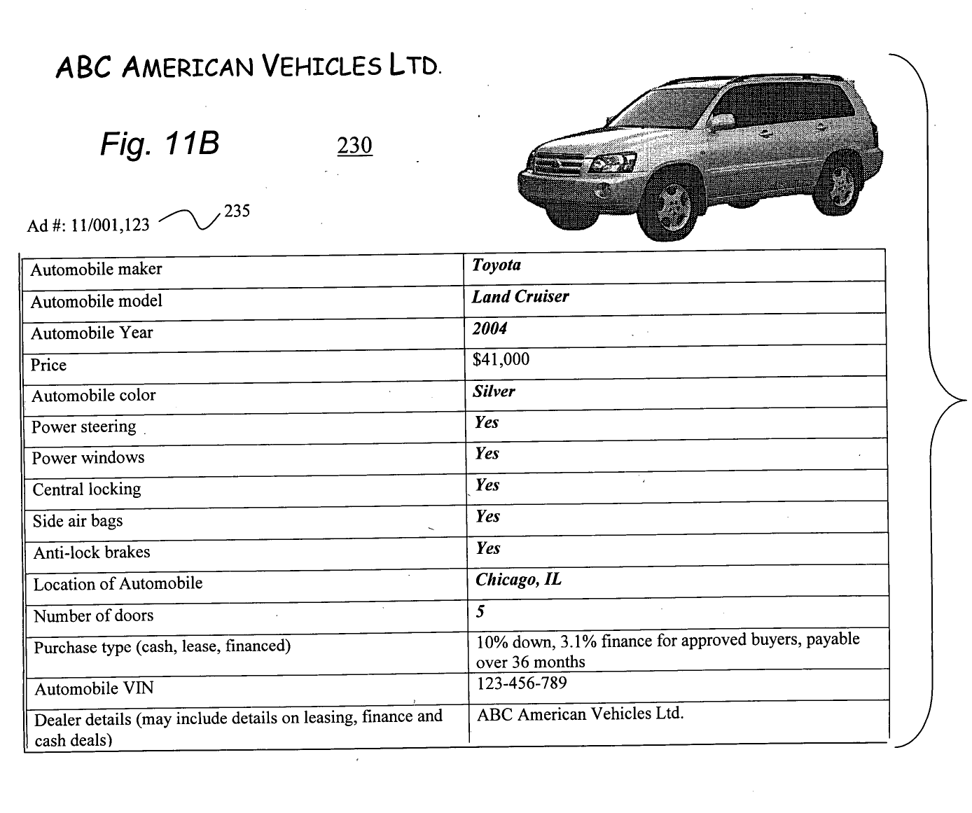

In one embodiment of the invention, AD members (ADMs) are permitted to set up dealer ads (see FIG. 5), which can be stored in the AD members' area 180 of database 130, and AB members can set up their wish lists (see FIG. 4), which are stored on the AB members' area 160 of database 130. The ADM may upload a picture of the automobile offered for sale, which together the other information is presented as a dealer ad 230, an example of a dealer ad 230 is shown in FIGS. 11A and 11B. The dealer ads (i.e., ADM offerings) and ABM wish lists can include matching and non-matching fields. Examples of fields used for matching along with non-matching fields are shown in Table 1. It should be understood that the fields shown in Table 1 are illustrative only, and many other combinations could be used. Other suitable fields could be described using the User Program Language (UPL) code convention to include such fields as, but not limited to: automobileType (with, e.g., selection options: saloon cars, minivans, hybrids, trucks, SUVs, no preference) and newUsed (with, e.g., selection options: new, used, no preference) could also be used. Likewise for mileageRange, priceRange, transmissionManual (with, e.g., selection options: yes, no, no preference).

Other fields can be used such as transmission-Automatic (with, e.g., selection options: yes, no, no preference). Some fields could be set up such that selection can mean an automatic filling in of a related field, e.g., selecting manual could cause “no” to be entered automatically into the transmission-automatic field.

TABLE 1

| | | | Non-limiting examples of AB |
|---|---|---|---|
| | AD member Ad | | member wish list Fields |
| # | Fields | # | (i.e., auto-buyer preferences) |
| 1 | Automobile | 1′ | Desired automobile maker |
| | maker | | |
| 2 | Automobile | 2′ | Desired automobile model |
| | model | | |
| 3 | Automobile Year | 3′ | Desired automobile year |
| 4 | Price | 4′ | Desired price range |
| 5 | Automobile | 5′ | Desired automobile color |
| | color | | |
| 6 | Power steering | 6′ | Power steering required? |
| 7 | Power windows | 7′ | Power windows required? |
| 8 | Central locking | 8′ | Central locking required? |
| 9 | Side air bags | 9′ | Side air bags required? |
| 10 | Anti-lock | 10′ | Anti-lock brakes required |
| | brakes | | |
| 11 | Location of | 11′ | Desired location |
| | Automobile | | |
| 12 | Number of doors | 12′ | Desired number of doors |
| 13 | Deal | 13′ | Desired pricing deal |
| | | | (e.g., cash, leqase, finance) |
| 14 | Automobile VIN* | | |
| 15 | Dealer details* | | |
| *Fields 1 through 13 and corresponding fields 1′ through 13′ are matching fields, i.e., these fields are used to match buyer wish-list fields (1′ through 13′) to dealer ad fields (1 through 13). | | | |
| # The last two dealer ad fields (#14 and #15) have no corresponding fields in the buyer wish list fields. The last two dealer ad fields (#13 and #14) are non-matching information fields used for storing information that can be provided to buyers concerning automobiles for sale, | | | |
| # and in this example, have no corresponding field in the buyer wish list fields column. Many other combinations could obviously be used. To the extent state and/or national laws permit, the information fields can be regarded as optional, | | | |
| # however some information fields may be regarded as essential, such as the dealer field for showing the automobile's VIN (vehicle identification number); the terms “vehicle” and “automobile” are regarded as equivalent terms. | | | |

FIG. 4 shows example steps of how an automobile member (AB member or ABM) logs onto a website of the present invention. The ABM logs on remotely at 240, e.g., the ABM can log in from home via a cable modem. The ABM is invited to enter his/her user-ID a n d password at 260. Obviously, other information can be requested such as the buyer's name and address, telephone number, email address, preferred means of receiving, e.g., dealer ads, such as email and/or mobile phone. The processor or server 100 checks at 280 if the ABM has an authorized user-ID and password and if not provides the same at 300. Optionally, in addition to step 300, an email can be sent to the ABM's email account to validate the ABM's email account (e.g., the ABM's password might be restricted to a valid email address). To ensure that each ABM has a wish list set up, a check is made at 320 and if the ABM lacks a wish list, this is set up at 340. A unique wish list identifier number is optionally created and assigned to each newly created wish list somewhat like the allocation of a patent serial number (sometimes called a patent application number) which is assigned by OIPE (Office of Initial Patent Examination) to each patent application filed with the U.S. Patent and Trademark Office (USPTO). For the purposes of tagging wish list identifier numbers, updated wish lists can optionally be regarded as newly created wish lists and assigned a new identifier number. The unique wish list identifier number can be added as a non-matching field, e.g., see Table 2 and example entry AB(101,15). The ABM continues activities on the website at 360.

FIG. 5 shows example steps of how an automobile dealer member (AD member or ADM) logs onto a website of the present invention. The ADM logs on remotely at 400, e.g., the ADM can log in from a work or business based computer via a T1 line. The ADM is invited to enter his/her user-ID and password at 420. Optionally, in addition to step 300, an email can be sent to the ADM's email account to validate the ADM's email account (e.g., the ADM's password might be restricted to a valid email address) Obviously, other information can be requested such as the dealer's business name and address, telephone number, email address, preferred means of receiving, e.g., qualified buyer wish lists, such as via email, and/or mobile phone. The processor or server 100 checks at 440 if the AMD has an authorized user-ID and password and if not provides the same at 460. To ensure that each ADM has a least one ad set up, a check is made at 480 and if the ADM lacks a dealer ad, this is set up at 500. A unique ad identifier number (represented by numeric label “235” in FIGS. 11A and 11B) can be created and tagged to each ad somewhat like the allocation of a patent serial number (sometimes called a patent application number) which is assigned by OIPE (Office of Initial Patent Examination) to each patent application filed with the U.S. Patent and Trademark Office (USPTO). The ADM continues activities on the website at 520. The creation date of each ADM ad can be automatically recorded, tagged to each dealer ad, and optionally displayed on each dealer ad 230. This date is represented by numeric label “237” in FIG. 11A.

Still referring to FIG. 5, the ADM sets up a dealer ad at 500. At this point, or at any point when the ADM is active on the website at 520, the ADM is optionally invited to upload an electronic (e.g., digital picture or file) of his/her company logo (represented by numeric label “250” in FIG. 11A). Unless superseded by the ADM, this logo is integrated into all dealer ads placed by this ADM. Similarly, the ADM is optionally invited to upload an electronic picture of the automobile on offer (represented by numeric label “255” in FIG. 11A). Thus, the website according to the present invention has a number of optional functions which provide the basis for the website owner to product differentiate the website. For example, the website owner can offer a standard dealer deal and a deluxe deal and, for example, the deluxe deal can include such optional features as dealer uploads of company logos. From the standpoint of the ADM, this makes for a pleasurable experience in selling automobiles to ABMs.

AB member preferences can be defined as follows: AB1, AB2, . . . ABn; see Table 2. Given that there is more than one AB member, the variable can be treated as a two dimensional entity such as AB(i,j), where “i” represents a numeric identifier corresponding to a particular member and “j” references a particular field in the AB member wish list. Thus, for AB member #101 and field #6, which in Tables 2 corresponds to the field “Power steering”, for which three possible answers might be offered: “YES”, “NO”, “NO PREFERENCE”, which in turn may be allocated three numerical values: 1, 2 and 3, respectively.

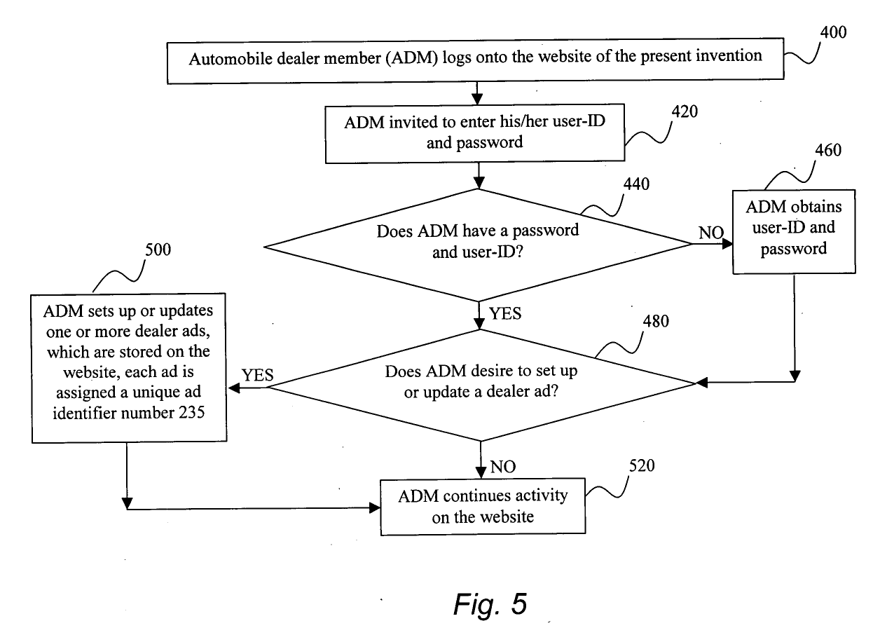

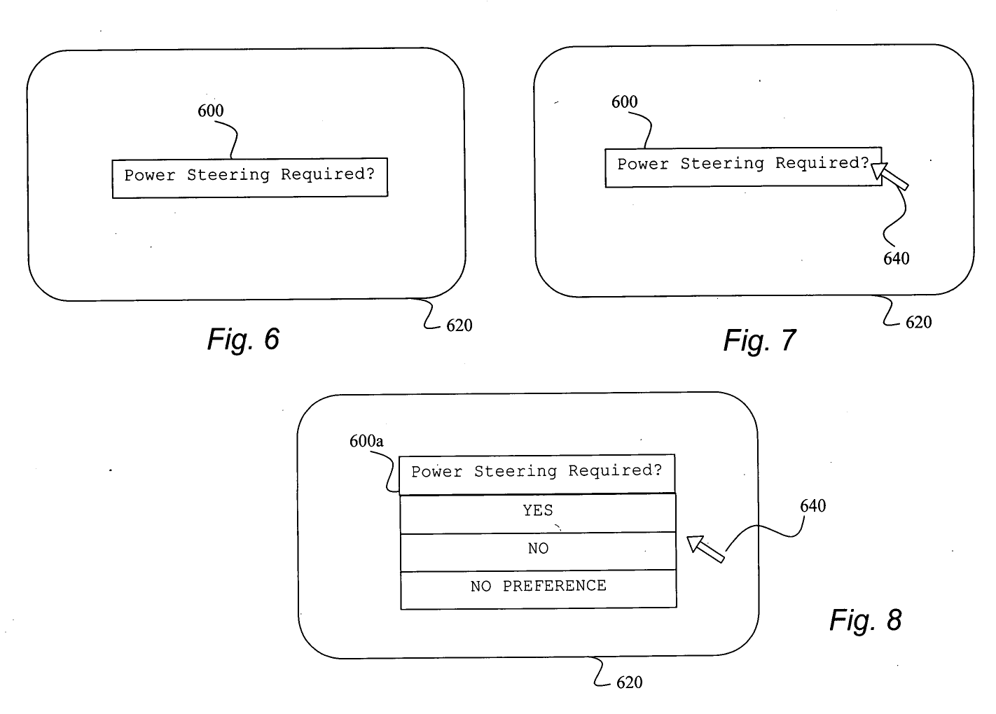

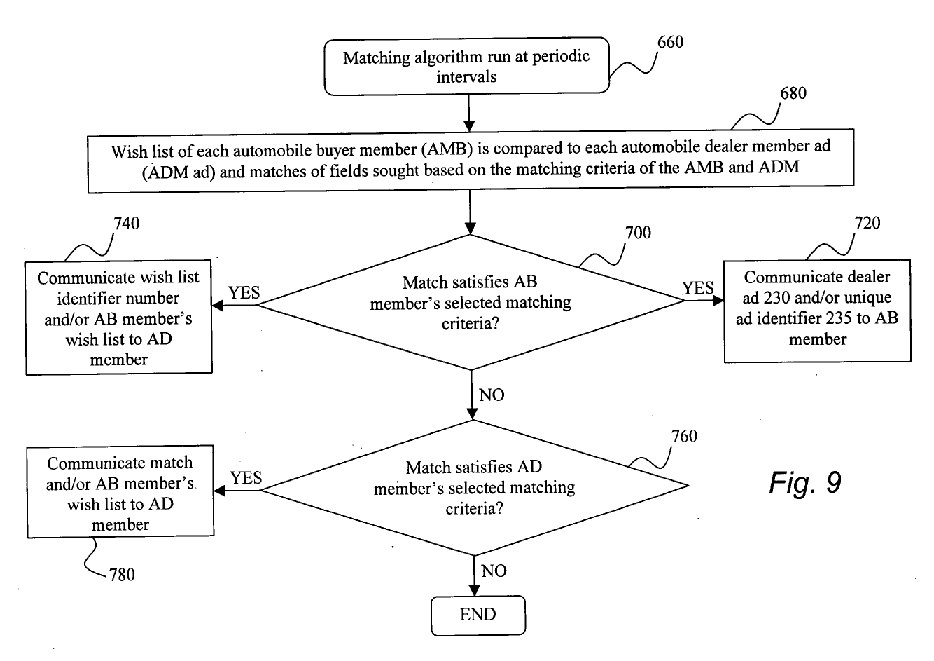

An exemplary pull down menu 600 for the “power steering” selection is shown displayed on screen 620 (see FIGS. 6-8). An AB member (ABM) can select if they want power steering by clicking on the power steering field 600 with a pointer 640 (FIGS. 7 and 8), and this causes a drop down menu to appear 600 (actually represented by alpha-numeral 600a in FIG. 8). The AB member can select their pick by clicking on either the “YES”, “NO” or “No Preference” choices using pointer 640. For example, if AB member #101 selected the second option “No”, then AB(101,6) would store “2”. Once the ABM has filled in a wish list (e.g., at 340 in FIG. 4), a unique wish list identifier number can be automatically assigned to the ABM's wish list, e.g., see Table 2 and example entry AB(101,15). Likewise, the date each ABM wish list is created or updated can be generated automatically and stored in a field, e.g., AB(101,16), not shown in Table 2.

Corresponding AD member offerings (i.e., ads, see FIG. 5) in terms of automobile specifications offered can be defined as follows: AD1, AD2, . . . ADn. Given that there is more than one AD member, the variable can be treated as a two dimensional entity such as AD(k,m), where “k” represents a numeric identifier corresponding to a particular AD member and “m” references a particular field in the AD member's ad. Thus, for AD member #20 and field #7, which in Table 3 corresponds to the field “Power windows”; in this example, the AD member can enter one of two allowed selections: yes or no, which numerically could equate to 1 and 2, respectively.

TABLE 2

| AB(i, j) | Wish List Fields for AB member #101 |
|---|---|
| AB(101, 1) | Desired automobile maker |
| AB(101, 2) | Desired automobile model |
| AB(101, 3) | Desired automobile year |
| AB(101, 4) | Desired automobile price range (user selects |
| | lower and upper price range) |
| AB(101, 5) | Desired automobile color |
| AB(101, 6) | Power steering required? |
| AB(101, 7) | Power windows required? |
| AB(101, 8) | Central locking required? |
| AB(101, 9) | Side air bags required? |
| AB(101, 10) | Anti-lock brakes required? |
| AB(101, 11) | Desired location |
| AB(101, 12) | Desired number of doors |
| AB(101, 13) | Desired pricing deal (cash, lease, finance) |
| AB(101, 14) | Required match (e.g., in % terms)* |
| AB(101, 15) | wish list identifier number** |

*As an option, each AB member can select a buyer desired match level, e.g., 100% match, at least 80% match, at least 60% match or at least 50% match. Only matches that meet or exceed the match cutoff are communicated to the corresponding AB member.
**Additional non-matching field can be used for storing a unique wish list identifier number.

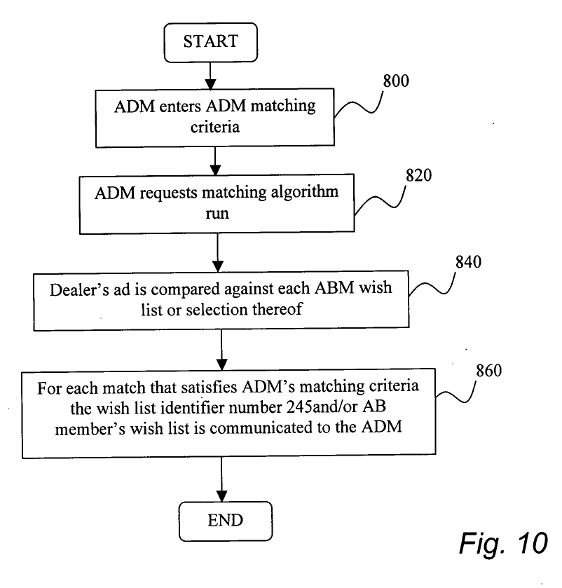

TABLE 3

| AD(k, m) | Ad Fields for AD Member #20 |
|---|---|
| AD(20, 1) | Automobile maker |
| AD(20, 2) | Automobile model |
| AD(20, 3) | Automobile Year |
| AD(20, 4) | Price of automobile |
| AD(20, 5) | Automobile color |
| AD(20, 6) | Power steering |
| AD(20, 7) | Power windows |
| AD(20, 8) | Central locking |
| AD(20, 9) | Side air bags |
| AD(20, 10) | Anti-lock brakes |
| AD(20, 11) | Location of Automobile |
| AD(20, 12) | Number of doors |
| AD(20, 13) | Purchase type (cash, lease, financed) |
| AD(20, 14) | Automobile VIN* |
| AD(20, 15) | Dealer details (may include details on leasing, finance |
| | and cash deals, free service for a year, free tires for |
| | life, or free oil changes)* |
| AD(20, 16) | Dealer matching criteria (e.g., in % terms)** |
| *In this example, not used as matching fields. | |
| **As an option, each AD member can select a dealer desired match criteria, e.g., 100% match, at least 80% match, at least 60% match or at least 50% match. Only matches that meet or exceed the dealer match criteria are communicated to the corresponding AD member; | |
| # e.g., a wish-list that meet a dealer's desired match criteria is communicated to the dealer, the dealer is then able to update his/her ad or upload a new ad that more closely matches the wish-list of the AB member, thus when the next match search is run | |
| # (see, e.g., FIG. 9), the more closely matching dealer ad will likely be communicated to the AB member. Thus, a dealer can, for example, look out onto his/her dealer lot and find a automobile that more closes matches the buyer's requirements | |
| # thus improving turn-over and profit for the dealer while providing buyers with automobiles that more closely match their automobile preferences (as expressed in buyers' wish lists). | |

An integral part of the present invention is a matching methodology that matches dealer ads with buyer wish lists, and matches are communicated to buyers (see, e.g., FIG. 3). In another embodiment, the reporting methodology applies dealer matching criteria and matches that satisfy the dealer matching criteria are communicated to dealers along with buyer wish lists, but absent personal information to avoid dealers learning the identity or contact information of the buyers. This non-obvious way of detecting and reporting matches provides a formalized methodology for automobile dealers to quickly identify automobile buyers while providing buyers with an efficient means for identifying automobiles that closely match their preferences as expressed in their buyer wish lists.

Methods of matching fields are well known, and discussed for example, in U.S. Patent Numbers: U.S. Pat. No. 5,283,731 (issued to Lalonde et al.) and U.S. Pat. No. 6,751,597 (issued to Brodsky et al.). The '731 Lalonde et al. and '597 Brodsky et al. patents are herein incorporated by reference in their entirety.

In one embodiment of the present invention, the matching methodology is combined with a matching-cutoff (based on individual ABM and/or ADM matching criteria) to increase the quality of matches communicated to the members (auto-buyers and/or dealers). The matching-cutoff can be defined in any suitable mathematical manner and may simply be a % match score or ratio of matches versus non-matches, e.g., a dealer selected matching-cutoff of 0.5 would mean a match between a dealer's ad and a AB member's wish-list would only be reported to that dealer if there was at least 50% matches between the fields of the dealer's ad and a member's wish-list (for guidance, see Table 1). In this embodiment of the present invention, each AB member and AD member can set the severity of the matching cutoff such that the matching cutoff criteria is not fixed by the system, but rather individually selected by each automobile dealer and automobile buyer member.

FIG. 9 shows a logic flow chart of matching methodology in combination with a matching-cutoff according to one embodiment of the present invention. In this embodiment, a matching algorithm is run at periodic intervals at 660. Wish lists of each AB member are compared in turn against each automobile dealer ad (ADM ad) at 680. For each comparison of fields between each wish list and each dealer ad, the respective ABM matching criteria is applied at 700. If the comparison meets the ABM matching criteria, the dealer ad 230 (see FIG. 11A) or unique dealer ad identifier number 235 (see FIG. 11A or 11B) is communicated to the respective automobile buyer member (ABM) at 720. The ADM can, if he/she so desires, look up the dealer ad by logging onto the server 100 to view the dealer ad with unique identifier number 235. Matching fields can be highlighted (matching fields are shown in bold italics in FIG. 11B). Highlighting matching fields aids the ABM when viewing dealer ads. The form of highlighting can vary, e.g., matching fields might be shown in a different color from non-matching fields.

Still referring to FIG. 9, optionally, the ABM's wish list is communicated to the respective ADM (the ADM who placed that dealer ad) at 740. This is important because the ADM may want to tweak his/her dealer ad or formulate a new dealer ad that more closely matches the ABM's wish list; this could be done at 500 (see FIG. 5). If the comparison does not meet the ABM's selected matching criteria at 700, the comparison is further examined at 760 to see if the comparison satisfies ADM's selected matching criteria, which might be less stringent than the respective ABM's matching criteria used at 700. If the comparison made at 760 satisfies the ADM's selected matching criteria, then the respective ABM's wish list is communicated to the ADM at 780.

It should be understood that steps 700 and 760 in FIG. 9 can occur together or in reverse order. Also, matches that satisfies an ABM's matching criteria at 700 can optionally be stored on the ABM's webpage 220 (FIG. 3) and, more specifically, the corresponding dealer's ad that satisfied the ABM's matching criteria can be stored on the ABM's webpage 220 and thus available for the ABM to view upon logging into the website (see FIG. 4. More specifically, the ABM can view such dealer ads at 360 in FIG. 4.

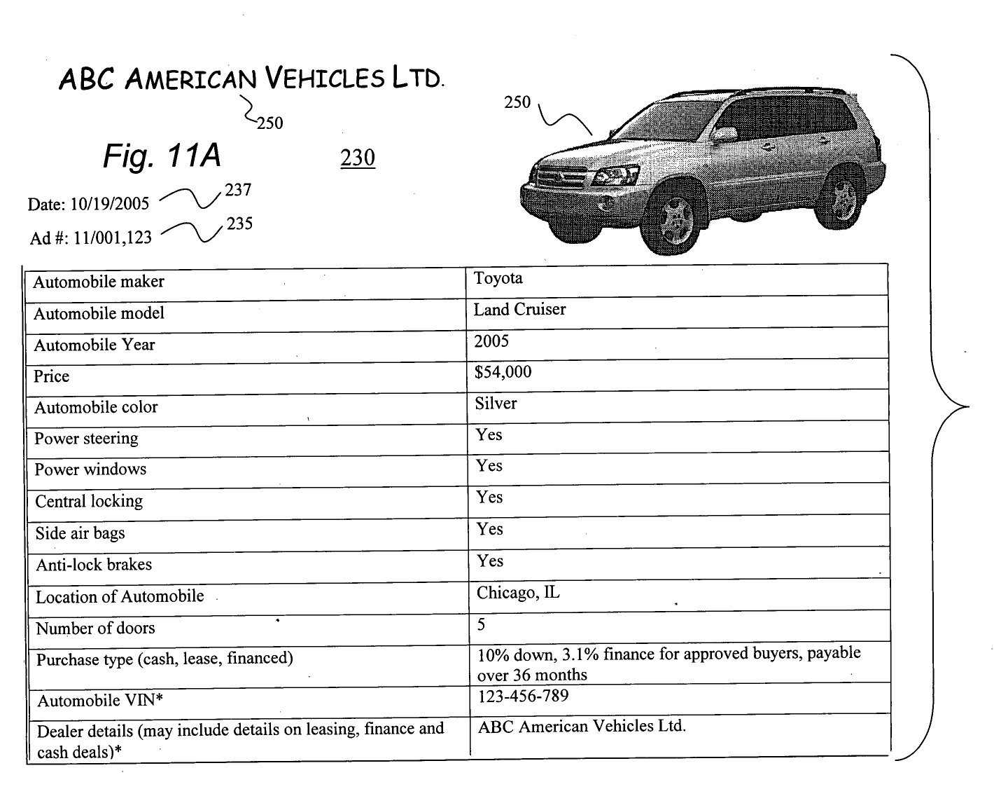

In a further embodiment, an ADM can request the matching algorithm to run purely on behalf of the ADM. This embodiment is outlined in FIG. 10, where an ADM (AD member) enters his/her preferred ADM matching criteria at 800 and requests the matching algorithm to run at 820. The ADM ad is compared against each ABM wish list or selection thereof at 840. For each match that satisfies the ADM matching criteria, the respective wish list identifier number 245 and/or ABM's corresponding wish list is communicated to the respective ADM at 860. The ADM can use such wish lists to formulate or tailor more dealer ads. In a sense, the ADM is allowed by the software of the invention to fish for ABM's who have a desire to purchase automobiles from the ADM.

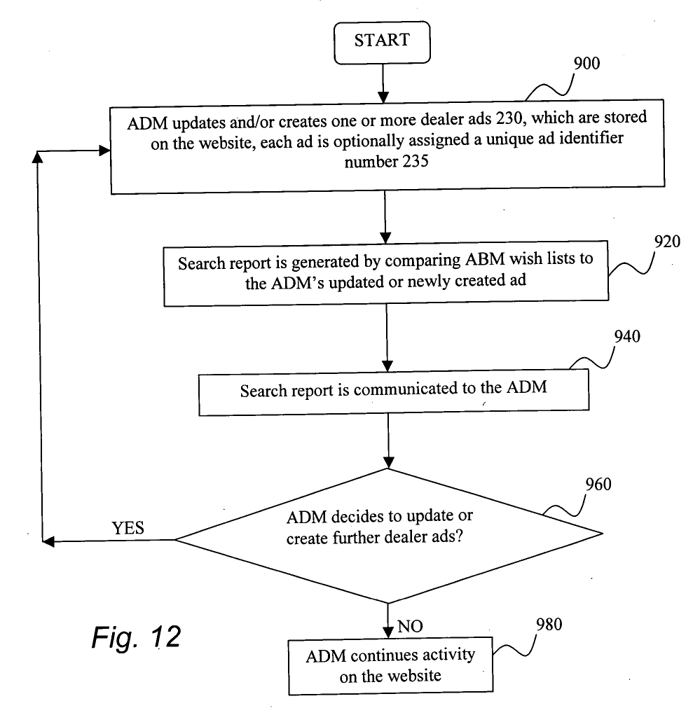

FIG. 12 shows the logic steps in another aspect of the present invention. An ADM creates or updates a dealer ad at 900. A search report is generated by comparing wish lists to the ADM's updated or created ad at 920. The processor 100 or suitable equivalent (such as, but not limited to, a server comprising a parallel array of, e.g., Alpha 64 bit processors, or a Sun Microsystems Enterprise server, or an Oracle 10g Grid Platform, etc.). The search report is communicated to the ADM at 940. The search report can comprise of a list of matches in ranked order of hits between fields entered by the ADM and ABMs. For example, the 20 top matches can be communicated to the ADM, e.g., the search report can include a list of wish list serial numbers 245 in ranked order, the ADM is then free to look up the wish lists, which should aid the ADM in further updating his/her dealer ads to generate even closer matches between the ADM's ads and ABMs wish lists. By an iterative process, the ADM can arrive at a set of dealer ads that offer the closest match between selected ABMs' wish lists and automobiles for sale, e.g., on the ADM's lot. For example, if a wish list desired a particular Isuzu SUV model and the ADM had that model on his/her lot, then the ADM could see if he/she can accommodate the price term most desired by a particular ABM as expressed in their wish list.

Still referring to FIG. 12, in response to the search report, the ADM decides at 960 whether to update or create further dealer ads. If the ADM decides his/her search report is OK, then the ADM can continue his/her activity at 980 otherwise the ADM can return to updating and/or creating new dealer ads at 900. FIG. 12 speaks to giving the ADM one or more chances to arrive at a situation where the ADM is likely to achieve sales on one or more of his/her automobiles.

FIG. 13 speaks to yet another embodiment in which updated and/or newly create dealer ads at 1000 trigger a matching search of ABM wish lists at 1020, which are subjected to the matching criteria set by each ABM at 1040. A check is made at 1060 and those dealer ads and/or unique ad identifiers that satisfy the matching criteria are communicated to the respective ABMs at 1080. It should be understood that in the event an ABM does not enter a matching criteria, an arbitrary matching criteria can be arbitrarily imposed by the invention such as, but not limited to, 0.5 (corresponding to 50% match requirement).

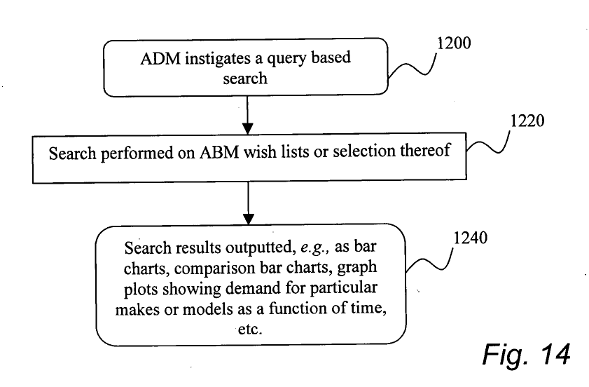

FIG. 14 speaks to ADMs data-mining among ABM wish lists. An ADM instigates a search at 1200, the search is performed at 1220, and the results outputted at 1240. The search requests can vary. For example, demand for a particular automobile model can be found by searching ABM wish list fields that speak to desired model type and the data expressed as a function of time or by geographical location of the ABMs.

In a further embodiment of the invention, the invention is a website that comprises the functionality disclosed in FIG. 9.

In a further embodiment of the invention, the invention is a website that comprises the functionality disclosed in FIG. 10.

In a further embodiment of the invention, the invention is a website that comprises the functionality disclosed in FIG. 12.

In a further embodiment of the invention, the invention is a website that comprises the functionality disclosed in FIG. 13.

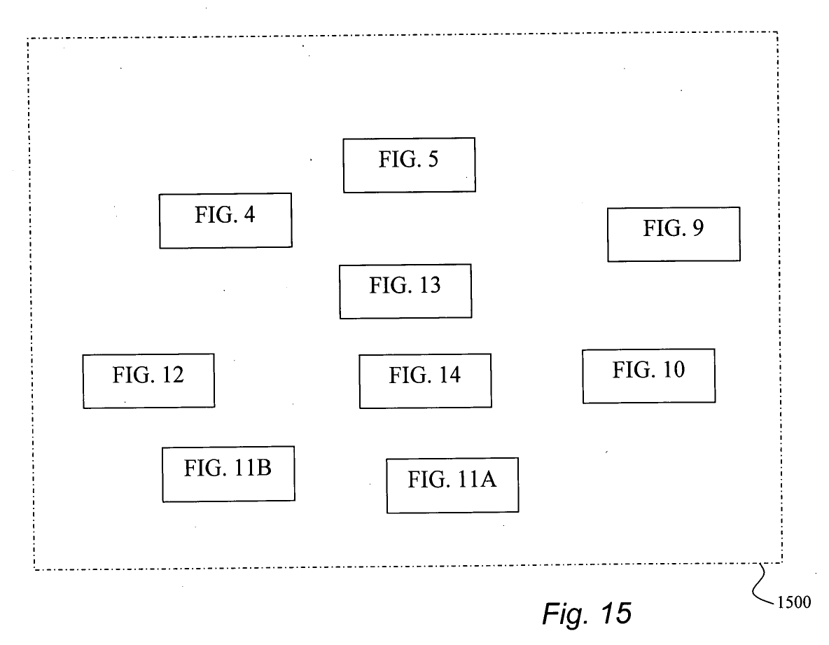

In a further embodiment of the invention, the invention is a website 1500 (see FIG. 15) that comprises the functionality disclosed in FIGS. 9, 10, 12, 13, and 14; and optionally FIGS. 4, 5, 11B, and 11A.

In a further embodiment, promotion offers/items such as free service for a year, free tires for life of the automobile, free oil changes for 5 years, etc. are equated to predetermined cash values, e.g., $500.00, $1,000.00, and $250.00, respectively. A field can be added (e.g., “promotion item desired” linked to a pull down menu offering selections; free service for a year, free tires for life of the automobile, free oil changes for 5 years) to the buyer's wish list (with a complementary field in the dealer's ad fields) that deals speaks to such offers.

It is to be understood that the present invention is not limited to the embodiments described above, but encompasses any and all embodiments within the spirit of the invention.

It is claimed:

1. A website for marketing automobiles, the website comprising functionality as disclosed in FIG. 9.

2. The website for marketing automobiles of claim 1, further comprising functionality as disclosed in FIG. 10.

3. The website for marketing automobiles of claim 1, further comprising functionality as disclosed in FIGS. 10 and 12.

4. The website for marketing automobiles of claim 1, further comprising functionality as disclosed in FIGS. 10, 12 and 13.

5. The website for marketing automobiles of claim 1, further comprising functionality as disclosed in FIGS. 10, 12, 13 and 14.

6. A website for marketing automobiles, the website comprising functionality as disclosed in FIGS. 9, 10, 12, and 13, alone or in combination.

7. The website for marketing automobiles of claim 6, further comprising functionality as disclosed in FIG. 14.

8. A world wide web enabled computer system, comprising:
at least one processor for hosting a website, said website comprising functionality as disclosed in FIG. 9; and
a storage means, wherein said storage means is operably coupled to said processor, and wherein said storage means is used to host a plurality of partitions, said plurality of partitions comprise an automobile buyers' partition, an administration partition, and a automobile dealer's partition.
a processor for hosting a website, said website comprising functionality as disclosed in FIGS. 9, 10, 12, and 13, alone or in combination; and

9. The world wide web enabled computer system of claim 8, wherein said website further comprises the functionality as disclosed in FIG. 10.

10. The world wide web enabled computer system of claim 8, wherein said website further comprises the functionality as disclosed in FIGS. 10 and 12.

11. The world wide web enabled computer system of claim 8, wherein said website further comprises the functionality as disclosed in FIGS. 10, 12 and 13.

12. The world wide web enabled computer system of claim 8, wherein said website further comprises the functionality as disclosed in FIGS. 10, 12 13, and 14.

13. The world wide web enabled computer system of claim 8, wherein said website further comprises the functionality as disclosed in FIGS. 10, 11A, 11B, 12, 13, and 14.
